(19) United States
(12) Patent Application Publication
(10) Pub. No.: US 2017/0270771 A1
(43) Pub. Date: Sep. 21, 2017

(54) SYSTEM AND METHOD FOR DETECTING ABNORMAL WORK OF INDUSTRIAL DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 15/215,591

(22) Filed: Jul. 21, 2016

(30) Foreign Application Priority Data
Mar. 17, 2016 (CN) 201610151591.1

(51) Int. Cl. G08B 21/18; G05B 19/418

(52) U.S. Cl. CPC G08B 21/187; G05B 19/41875

(57) ABSTRACT

In an abnormal work detecting method for an industrial device, running data of an industrial device is obtained at a predefined time interval. The running data is determined whether the running data falls with a range of a predefined initial data, the range of the predefined initial data indicating the industrial device is normally running. If no, a position of the detection device is obtained by the position device. A warning message is generated to remind a maintainer of the industrial device a position where the industrial device works abnormally.

### CROSS-REFERENCE TO RELATED APPLICATIONS

This application claims priority to Chinese Patent Application No. 201610151591.1 filed on Mar. 17, 2016, the contents of which are incorporated by reference herein.

### FIELD

The subject matter herein generally relates to industrial devices, and more specifically relates to a system and a method for detecting abnormal work of an industrial device.

### BACKGROUND

The fourth industrial revolution brings more and more automatic production equipments to be used industrial manufacture, such as or intelligent robots. However, the malfunction diagnosis and removal of the automatic production equipments are currently manually operated by workers, which waste human labors and increase maintenance costs.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing an abnormal work detecting system of an industrial device.

FIG. 2 is a block diagram of one embodiment of function modules of the abnormal work detecting system in FIG. 1.

FIG. 3 is a flowchart of one embodiment of an abnormal work detecting method for an industrial device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

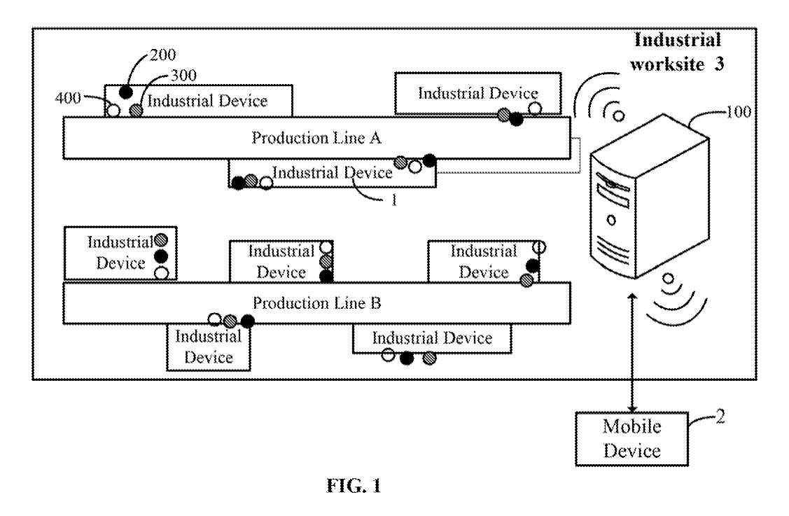

FIG. 1 illustrates an industrial worksite for executing an abnormal work detecting system of an industrial device. The abnormal work detecting system 10 is installed and runs in a device or devices of an industrial worksite 3, for example a server 100.

The industrial worksite 3 includes one or more industrial device 1. Each industrial device 1 includes a lot of parts. The parts of the industrial device 1 may cannot work normally. A detection device 200 is installed in a position corresponding to a part of the industrial device 1 that may work abnormally. The detection device 200 can detect running data of the industrial device 1 when the part of the industrial device 1 is running. The running data can include, but be not limited to, voltage information, current information, temperature information, vibration frequency information, and so on. In the embodiment, the industrial device 1 can be a coal mining machine or an oil field equipment.

In the illustrated embodiment, the industrial worksite 3 includes a number of position devices 300 and a number of camera devices 400. One position device 300 and one camera device 400 are assigned to a corresponding detection device 200. The position device 300 can obtain a position of the corresponding detection device 200 via an accurate indoor positioning technology. The cameras device 400 can capture pictures of a position where the corresponding detection device 200 locates. In the embodiment, the camera device 400 can be industrial camera, or a light field camera. The server 100 connects and communicates with the detection devices 200, the position devices 300, and the camera device 400 via a network. The network can be one element selected from the General Packet Radio Service (GPRS) network, the Code Division Multiple Access (CDMA) network, the 3rd Generation (3G) Telecommunication network, the 4th Generation (4G) Telecommunication network, WIFI, or Bluetooth. The server 100 further connects and communicates with one or more mobile device 2 via the network. In the embodiment, the server 100 communicates with the mobile device 2 owned by a maintainer via WIFI. The mobile device 2 can be a tablet computer, a notebook computer, a smart phone, a personal digital assistant (PDA), or other suitable electronic device.

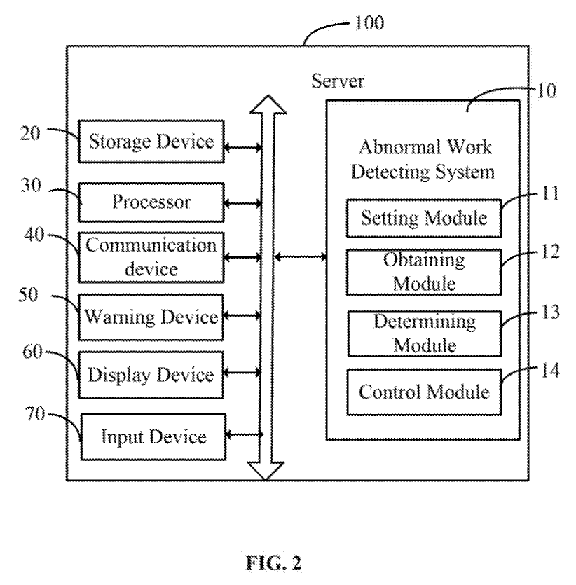

FIG. 2 illustrates modules of the server 100. In at least one embodiment as shown in FIG. 2, the server 100 includes, but is not limited to, a storage device 20, at least one processor 30, a communication device 40, a warning device 50, a display device 60, and an input device 70. The at least one processor 30 can communicate and connect with the storage device 20, the communication device 40, the warning device 50, the display device 60, and the input device 70. FIG. 2 illustrates only one example of the server 100; other can include more or fewer components than illustrated, or have a different configuration of the various components in other embodiments.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The storage device 20 can store program codes of program applications installed on the server 100 and all data that can be used by the program applications.

The at least one processor 30 can be a central processing unit (CPU), a microprocessor, or other data processor chip that performs functions of the industrial device abnormal work detecting system 10 in the server 100. The communication device 40 can connect and communicate with the detection device 200, the position devices 300, the camera device 400, and the mobile device 2. The communication device 40 can be a Bluetooth device, a WIFI device, or a Zigbee device. The warning device 50 can show a prompt to remind maintainers when a malfunction happens to the industrial device 1. The warning device 50 can be a pilot lamp, speaker, or a vibration motor. The display device 60 can display a user interface indicating the industrial device abnormal work detecting system 10 is running in the server 100. The input device 70 can be a mouse, a keyboard, or a touch panel, and configured to input data in response to user's operation. In one embodiment, the display device 60 can display a prompt message or prompt mark to remind the maintainer that a malfunction happens to the industrial device 1. In an alternative embodiment, the display device 6 cooperates with the input device 70 to form a touch screen.

The industrial device abnormal work detecting system 10 can obtain running data of an industrial device at a predefined time interval. The industrial device abnormal work detecting system 10 can determine whether the running data falls within a range of a predefined initial data which indicates the industrial device is normally running. When the running data does not fall within the range of the predefined initial data, the industrial device abnormal work detecting system 10 can obtain a position of the detection device 200 through the position device 300. And, the industrial device abnormal work detecting system 10 can generate a warning message to remind a maintainer of the industrial device 1 of a position where the industrial device 1 works abnormally.

FIG. 2 also illustrates the function modules of the industrial device abnormal work detecting system 10. In at least one embodiment, the industrial device abnormal work detecting system 10 can include a setting module 11, an obtaining module 12, a determining module 13, and a control module 14. The function modules 11-14 can include computerized codes in the form of one or more programs, which are stored in the storage device 20. The at least one processor 30 executes the computerized codes to provide functions of the function modules 11-14.

The setting module 11 can provide a user interface for user to set initial data in response to operations on the user interface. The setting module 11 can store the initial data into the storage device 20.

The initial data can include identity codes of the detection devices 200, identity codes of the position devices 300, identity codes of the camera device 400, and identity codes of the industrial devices 1, and relationship among the detection devices 200, the position devices 300, the camera devices 400, and the industrial devices 1. The initial data further includes objects to be detected by the detection devices 200 and value range of the objects when the industrial device 1 is normally running. The objects can be, but is not limited to, voltage information of the industrial device 1, current information of the industrial device 1, temperature information of the industrial device 1, vibration frequency information of the industrial device 1, and so on.

The obtaining module 12 can obtain running data of the industrial device 1 detected by the detection device 200 at a predefined time interval.

The determining module 13 can determine whether the running data falls within a range of the predefined initial data.

In the embodiment, the obtaining module 12 obtains the identify code of the detection device 200 while obtaining the running data of the industrial device 1, then obtains the predefined initial data of the industrial device 1 corresponding to the detection device 200 from the storage device 20.

In the embodiment, the determining module 13 firstly determines whether the running data is greater than a maximum value of the range of the predefined initial data. When the running data is less than the maximum value, the determining module 13 then determines whether the running data is greater than a minimum value of the range of the predefined initial data. When the running data is less than the maximum value and greater than the minimum value, the determining module 13 determines the running data falls within the range of the predefined initial data. In an alternative embodiment, the determining module 13 can firstly determine whether the running data is greater than a minimum value of the range of the predefined initial data. When the running data is greater than the minimum value, the determining module 13 then determines whether the running data is less than a maximum value of the range.

When the determining module 13 determines that the running data does not fall within the range of the predefined initial data, that is, the industrial device 1 in the place where the detection device 200 locates works abnormally; the obtaining module 12 obtains a position of the detection device 200 obtained by the position device 300.

The control module 14 can generate warning message to remind a maintainer of the industrial device a position 1 where the industrial device works abnormally. The position where the industrial device 1 works abnormally corresponds to the position of the detection device 200 by which the running data detected does not fall within the range of the predefined initial data.

The control module 14 can further generate a control command and send the control command to the camera device 400 corresponding to the detection device 200. The camera device 400 can capture pictures or a video of a position where the industrial device 1 fails. In an alternative embodiment, the control module 14 controls the display device 60 to display position of the detection device 200 and the pictures or vides captured by the camera device 400. Thereby, the maintainers can know the position where the malfunction or what kind of malfunction happens to the industrial device 1 according to the pictures or vide displayed by the display device 60.

The control module 14 further sends the control command to the warning device 50 and controls the warning device 50 to show the warning message through a predefined way. Thereby, then the maintainers know that the industrial device 1 works abnormally.

The storage device 20 stores a map of the industrial worksite 1, the control module 14 marks the positions where the industrial device 1 fails in the map of the industrial worksite 3. The control module 14 can control the display device 60 to display marked positions. The control module 14 sends the position and the pictures or video to the mobile device 2, thus making the maintainers to know the running state of the industrial device 1.

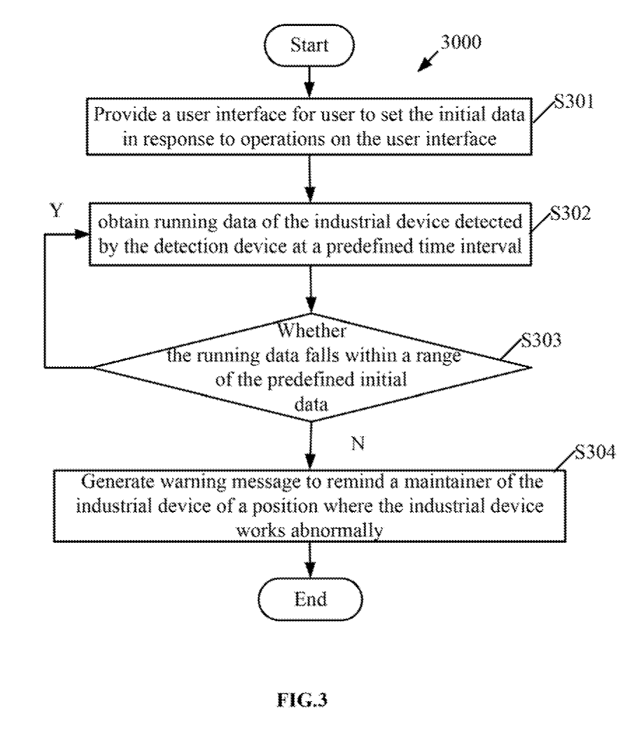

FIG. 3 is a flowchart of one embodiment of an abnormal work detecting method for an industrial device. The example method 3000 is provided by way of example, as there are a variety of ways to carry out the method. The method 3000 described below can be carried out using the configurations illustrated in FIGS. 1 and 2, for example, and various elements of these figures are referenced in explaining example method 3000. Each block shown in FIG. 3 represents one or more processes, methods or subroutines, carried out in the exemplary method 3000. Additionally, the illustrated order of blocks is by example only and the order of the blocks can change. The exemplary method 3000 can begin at block 301. Depending on the embodiment, additional steps can be added, others removed, and the ordering of the steps can be changed.

At block 301, the setting module provides a user interface for user to set the initial data in response to operations on the user interface.

At block 302, the obtaining module obtains running data of the industrial device detected by the detection device at a predefined time interval.

At block 303, the determining module determines whether the running data falls within a range of the predefined initial data? If yes, the process goes back to block 302; if no, the process goes to block 304.

In the embodiment, the determining module 13 firstly determines whether the running data is greater than a maximum value of the range of the predefined initial data. When the running data is less than the maximum value, the determining module 13 then determines whether the running data is greater than a minimum value of the range of the predefined initial data. In an alternative embodiment, the determining module 13 can firstly determine whether the running data is greater than a minimum value of the range of the predefined initial data. When the running data is greater than a minimum value, the determining module 13 then determines whether the running data is less than a maximum value of the range.

At block 304, the control module generates warning message to remind a maintainer of the industrial device of a position where the industrial device work abnormally.

In the embodiment, the position where the industrial device 1 work abnormally corresponds to the position of the detection device 200 by which the running data detected does not fall within the range of the predefined initial data.

The control module 14 can further generate a control command and send the control command to the camera device 400 corresponding to the detection device 200. The camera device 400 can capture pictures or a video of a position where the industrial device 1 fails. In an alternative embodiment, the control module 14 controls the display device 60 to display position of the detection device 200 and the pictures or vides captured by the camera device 400. Thereby, the maintainers can know the position where the malfunction or what kind of the malfunction happens to the industrial device 1 according to the pictures or vide displayed by the display device 60.

The control module 14 further sends the control command to the warning device 50 and controls the warning device 50 to show the warning message through a predefined way. Thereby, then the maintainers know that the industrial device 1 works abnormally.

The storage device 20 stores a map of the industrial worksite 1, the control module 14 marks the positions where the industrial device 1 works abnormally in the map of the industrial worksite 3. The control module 14 can control the display device 60 to display marked positions. The control module 14 sends the position and the pictures or video to the mobile device 2, thus making the maintainers to know the running state of the industrial device 1.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An abnormal work detecting method for an industrial device to be executed by at least one processor of a computing device, the method comprising:
obtaining running data of an industrial device at a predefined time interval, wherein the industrial device is installed with one or more detection devices for detecting which parts of the industrial device work abnormally, the running data is detected by the detection device;
determining whether the running data falls within a range of a predefined initial data in which the industrial device works normally;
obtaining a position of the detection device when the running data does not fall within the range of the predefined initial data; and
generating a warning message to remind a maintainer of the industrial device a position where the industrial device works abnormally according to the position of the detection device.

2. The abnormal work detecting method according to claim 1, wherein the position where the industrial device works abnormally corresponds to the position of the detection device which detects the running data does not fall within the range of the predefined initial data.

3. The abnormal work detecting method according to claim 2, further comprising:
showing the warning message to the maintainer via a warning device.

4. The abnormal work detecting method according to claim 2, further comprising:
capturing pictures or video of the position where the industrial device works abnormally; and
displaying the pictures or video of the position via a display device when the running data does not fall within the range of the predefined initial data.

5. The abnormal work detecting method according to claim 4, further comprising:
generating a mark to mark the position where the industrial device works abnormally in a map of an industrial worksite to which the industrial device is applied; and
displaying the position associated with the mark.

6. The abnormal work detecting method according to claim 4, further comprising:
transmitting the pictures of video of the position to a mobile device which owned by the maintainer of the industrial device.

7. An electronic device comprising:
a processor; and
a storage device that stores one or more programs which, when executed by the at least one processor, cause the processor to:
obtain running data of an industrial device at a predefined time interval, wherein the industrial device is installed with one or more detection devices for detecting which parts of the industrial device work abnormally, the running data is detected by the detection device;
determine whether the running data falls within a range of a predefined initial data in which the industrial device works normally;
obtain a position of the detection device when the running data does not fall within the range of the predefined initial data; and
generate a warning message to remind a maintainer of the industrial device a position where the industrial device works abnormally according to the position of the detection device.

8. The electronic device according to claim 7, wherein the position where the industrial device works abnormally corresponds to the position of the detection device which detects the running data detected does not fall within the range of the predefined initial data.

9. The electronic device according to claim 8, further the processor is caused to:
show the warning message to the maintainer via warning device.

10. The electronic device according to claim 8, wherein the processor is caused to:
capture pictures or video of the position wherein the industrial device works abnormally; and
display the pictures or video of the position via a display device when the running data does not fall within the range of the predefined initial data.

11. The electronic device according to claim 10, wherein the processor is caused to:
generate a mark to mark the position where the industrial device works abnormally in a map of an industrial worksite to which the industrial device is applied; and
display the position associated with the mark.

12. The electronic device according to claim 10, the processor is caused to:
transmit the pictures of video of the position to a mobile device which owned by the maintainer of the industrial device.

13. A non-transitory storage medium having stored thereon instructions that, when executed by a processor of an electronic device, causes the processor to perform an abnormal work detecting method for an industrial device, wherein the abnormal work detecting method comprises:
obtaining running data of an industrial device at a predefined time interval, wherein the industrial device is installed with one or more detection devices for detecting which parts of the industrial device work abnormally, the running data is detected by the detection device;
determining whether the running data falls within a range of a predefined initial data in which the industrial device works normally;
obtaining a position of the detection device when the running data does not fall within the range of the predefined initial data; and
generating a warning message to remind a maintainer of the industrial device a position where the industrial device works abnormally according to the position of the detection device.

14. The non-transitory storage medium according to claim 13, wherein the position where the industrial device works abnormally corresponds to the position of the detection device which detects the running data does not fall within the range of the predefined initial data.

15. The non-transitory storage medium according to claim 14, further comprising:
showing the warning message to the maintainer via warning device.

16. The non-transitory storage medium according to claim 14, wherein the method comprising:
capturing pictures or video of the position where the industrial device works abnormally; and
displaying the pictures or video of the position via a display device when the running data does not fall within the range of the predefined initial data.

17. The non-transitory storage medium according to claim 16, wherein the method comprising:
generating a mark to mark the position where the industrial device works abnormally in a map of an industrial worksite to which the industrial device is applied; and
displaying the position associated with the mark.

18. The non-transitory storage medium according to claim 16, the method comprising:
transmitting the pictures of video of the position to a mobile device which owned by the maintainer of the industrial device.
